(19) United States
(12) Patent Application Publication
(10) Pub. No.: US 2017/0317394 A1
(43) Pub. Date: Nov. 2, 2017

(54) HEAT EXCHANGER FOR A BATTERY

(71) Applicant: Obrist Technologies GmbH, Lustenau (AT)

(72) Inventors: Frank Obrist, Bregenz (AT); Martin Graz, Lustenau (AT); Joachim Georg Roth, Dornbirn (AT); Peter Giese, Herzogenaurach (DE)

(21) Appl. No.: 15/514,148

(22) PCT Filed: Sep. 22, 2015
(86) PCT No.: PCT/EP2015/071633

§ 371 Date: Jul. 26, 2017

(30) Foreign Application Priority Data
Sep. 26, 2014 (DE) 10 2014 114 024.9

(51) Int. Cl. H01M 10/625; H01M 10/643; H01M 10/6556; F28F 21/06; H01M 10/613; F28F 3/12; F28F 9/02; H01M 2/10

(52) U.S. Cl. CPC H01M 10/625; F28F 9/0263; H01M 10/643; H01M 2/1077; F28F 21/065; H01M 10/613; F28F 3/12; H01M 10/6556; F28F 2255/02; H01M 2220/20

(57) ABSTRACT

The invention relates to a heat exchanger for a battery, in particular for a hybrid drive, with connections for the inflow and outflow of a heat exchange medium and with a frame which is connected on both sides with film walls to form a pouch through which a flow can pass, wherein the frame comprises flow guiding elements The invention is characterised in that the frame comprises a separating plate with two parallel lateral surfaces, wherein the separating plate divides the pouch into a first chamber and a second chamber which are delimited in a fluid-tight manner by the lateral surfaces and the respective film walls, wherein in each of the lateral surfaces a channel field of parallel flow channels is formed, the inflow side of which is fluidically connected via a distributor channel and the outflow side of which is fluidically connected via a collecting channel to the respective connections. The invention also relates to a battery with at least one heat exchanger, a vehicle with one such battery as well as a manufacturing method for the heat exchanger.

The invention relates to a heat exchanger for a battery in accordance with the introductory section of claim 1. The invention also relates to a battery with such a heat exchanger, a vehicle with such a heat exchanger as well as a manufacturing method for the heat exchanger. A heat exchanger of the type mentioned above is known from EP 2 744 034 A1 for example, which belongs to the applicant.

The heat exchanger known from EP 2 744 034 A1 is designed as a heat exchanger which comprises two flexible film walls. On both sides the flexible film walls cover a frame in which flow guiding elements are arranged. A heat exchange medium can flow through the heat exchanger for which connections for the supply and drainage of the heat exchange medium are provided. The known heat exchanger is used for cooling a battery, wherein it has been shown that an increased cooling performance would be desirable.

The object of the invention is therefore to develop the heat exchanger further in such way that the cooling performance is increased. The object of the present invention is also to propose a battery with such a heat exchanger, a vehicle with such a battery as well as a method of manufacturing the heat exchanger.

According to the invention, in respect of the heat exchanger this object is achieved through the subject matter of claim 1, in respect of the battery through the subject matter of claim 9, in respect of the vehicle through the subject matter of claim 11 and in respect of the manufacturing method through the subject matter of claim 12.

The invention is based on the idea of proposing a heat exchanger for a battery, in particular for a hybrid drive, with connections for the supply and drainage of a heat exchange medium and with a frame, wherein the frame is connected on both sides with film walls to form a pouch through which a flow can pass. The frame has flow guiding elements. According to the invention the frame also has a separating plate with two parallel lateral surfaces, wherein the separating plate divides the pouch into a first chamber and a second chamber which are defined in a fluid-tight manner by the lateral surfaces and the respective film walls. In each of the lateral surfaces a channel field of parallel flow channels is formed, the inflow side of which is connected via a distributor channel and the outflow side of which is connected via a collecting channel to the respective connections.

Through the separating plate in the frame of the heat exchanger and the chambers thus formed in the pouch, the fluid flow of a heat exchange medium in the pouch through which a fluid can flow is optimised, as a result of which better heat uptake is brought about. The heat exchanger is therefore particularly suitable for cooling surrounding components and in thus far can form a cooling element.

The heat exchange medium reaches the distributor channel via a connection for the inflow of the heat exchange medium and from this it is evenly distributed to the parallel flow channels. The heat exchange medium flows through the parallel flow channels and reaches the collecting channel which bundles the flows of the individual flow channels and transfers them jointly to a connection for the outflow of the heat exchange medium. The structural design of the heat exchanger thus allows a constant and even flow through the pouch through which fluid can flow so that efficient heat exchanging is made possible.

In addition, the design of the heat exchanger with two chambers provides the possibility of deactivating one of the chambers by way, for instance, of a sealant or filler being introduced into one of the two chambers. In this way in series production a standard heat exchanger can be manufactured which can be adapted depending on the location of use. For example, if the heat exchanger is to be arranged between two cell blocks of a battery it is desirable for the heat exchange medium to flow through both chambers in order to achieve cooling of the two adjoining cell blocks. On the other hand, if the heat exchanger is arranged between a cell block and a structure that is not to be cooled, for example a housing wall of a battery, the chamber that is facing away from the cell block can be deactivated. This also contributes to the efficiency of the heat exchanger or the cooling system in which the heat exchanger is integrated.

In a preferred form of embodiment of the heat exchanger according to the invention the flow channels are orientated transversely to the longitudinal axis. Such a form of embodiment is not only advantageous for reasons of improved flow through the pouch, but also offers structural benefits with regard to the purpose of use of the heat exchanger. In this way the heat exchanger can also be used to support cell blocks. For this the frame is preferably designed to be so stable that battery cells, in particular their poles, can be supported on the frame, for example the flow guiding elements. To this extent the frame can form a spacer between the cell blocks.

In connection with this it is pointed out that cell blocks of a battery are usually made up of several battery cells, wherein the battery cells in the present case are preferably designed as round cells. The round cells can be arranged upright in rows next to each other so that the battery cells adjoin one another with their cylindrical outer surfaces. The battery cells can be connected to each other in parallel or in series by way of contact plates or contact sheets.

For simpler integration of the heat exchanger into a battery and for further optimisation of the heat exchanging capacity of the heat exchanger, according to a preferred form of embodiment of the invention the connections are provided on a narrow side of the pouch. The length of the flow channels can increase with increasing distance from the connections. Overall it can be envisaged that the flow channels of the channel field are of different lengths. A particularly good flow through the pouch is produced if the length of the flow channels increases the further the respective flow channel is arranged from the connections.

The maximum length of the flow channel can correspond to the width of the pouch. In particular it can be envisaged that a flow channel which is arranged furthest away from the connections has a length which corresponds to the width of the pouch. A flow channel of this type preferably has a lateral opening at each of its longitudinal ends which directly transitions into the distributor channel and the collecting channel respectively. More particularly such a lateral opening transitions into a longitudinal end of the distributor channel or collecting channel.

In relation to an even flow distribution within the pouch, it has also proven to be advantageous if the channel field comprises a first area with the same channel length, a second area with a constantly increasing channel length, a transition area with a greater increase in the channel length than in the second area and a third area with a constantly increasing channel length. The aforementioned areas can be arranged one behind the other along the longitudinal axis of the pouch, wherein the first area is arranged closest to the connections and the third area is at the greatest distance from the connections. The dimensions of the individual areas are preferably determined by way of flow calculations. It has proven to be particularly advantageous if a uniform flow speed establishes itself in all flow channels. In order to achieve this, the length of the individual flow channels varies in such a way that longer flow channels are arranged at a greater distance from the connections. Overall, over the entire heat-absorbing surface of the heat exchanger an even temperature distribution or even heat-absorbing capacity is thus produced.

A form of embodiment of the invention which is advantageous for the series production and for an even flow through the pouch envisages that the flow channels have a uniform width. As a result the height of the flow channels can increase from a connection-side end to an end of the heat exchanger opposite the connections. In order to set an even flow speed over all the flow channels it is expedient to adjust the flow cross-section of the individual flow channels as a function of the distance of the flow channels to the connections. It has proven to be particularly advantageous if the height of the flow channels is also increased with increasing distance from the connections. The width of the flow channels can therefore remain constant which is beneficial for even heat exchanging and for a stabilisation function which the frame can also provide for battery cells.

As the present heat exchanger has a separating plate which divides the pouch into a first chamber and a second chamber, it should be guaranteed that an adequate and even exchange of heat exchange medium between the two chambers takes place. For this, in preferred forms of embodiment it is envisaged that the separating plate has two openings which each emanate from the connections. An opening can be assigned to each of the inflow connection and outflow connection which preferably extends from the respective connection along the longitudinal axis of the pouch. Specifically it is envisaged that the openings each extend in parallel to the longitudinal axis of the pouch along the channel field, in particular along the first area and at least in sections along the second area.

The openings can end before the transition area. In doing so, the width of the openings can become narrower each time in the longitudinal direction of the pouch starting from the respective connection. This design has proven to be advantageous as in this way an even distribution of the heat exchange medium flowing in via the inflow connection to the first chamber and the second chamber is achieved. In an analogue manner to this, the opening assigned to the outflow connection makes even collection of the heat exchange medium from the first chamber and the second chamber possible in order to remove this from the pouch via the outflow connection. Each of the openings can be arranged in the distributor channel and in the collecting channel. It can also be envisaged that with their contours the openings follow the shape of the respective distributor channel or collecting channel.

With regard to the distributor channel, in preferred forms of embodiment it can be envisaged that its cross-sectional area reduces from a connection-side end of the heat exchanger to an end of the heat exchanger opposite the connections. In other words the distributor channel narrows starting from the connection in the direction of the opposite end of the heat exchanger. This also serves to equalise the flow speeds in the flow channels. As with increasing distance from the inflow connection a part of the supplied heat exchange medium is branched off on each flow channel and the flow in the distributor channel, adjustment of the flow cross-section is necessary in order to maintain a constant flow speed. This is achieved in the invention by the narrowing of the distributor channel. Inversely, in terms of its cross-sectional area the collector channel can widen to the outflow connection. This ensures that in spite of the increasing fluid volume which successively reaches the collecting channel from the flow channels in the direction of the outflow connection, a uniform flow speed in maintained in the collecting channel. For this it is preferably envisaged that the flow speeds in the distributor channel and in the collecting channel become equalised so that a continuous, more particularly neutral pressure fluid flow is ensured in the pouch.

According to a subordinate aspect of the invention, in the present application a battery is claimed which comprises at least one above-described heat exchanger. The battery can also comprise at least two cell blocks of round cells to be tempered, wherein the heat exchanger is arranged between the cell blocks. During operation the first chamber of the heat exchanger can temper one of the two cell blocks and the second chamber of the heat exchanger can temper the other of the two cell blocks. In connection with this the operating status covers both the separate or sole operation of the heat exchanger circulation and the combined operation of a heat exchanger circulation with energy circulation. In other words, during operation at least one heat exchange medium circulation is active, so that heat exchange medium circulates through the heat exchanger. Additionally, the cell blocks can also be in the operating mode wherein this applies both to the supply of electrical energy to the cell blocks (charging) as well as to the removal of energy from the cell blocks (discharging).

In a preferred form of embodiment of the battery according to the invention it is envisaged that for tempering a end-side cell block the chamber of the heat exchanger facing away from the cell block is filled with a filler which blocks the flow channels. This increases the energy efficiency of the system as heat exchange medium only has to continuously flow through the chamber which is in contact with the cell block to be tempered. The other chamber, which is not in contact with a cell block, is deactivated. This also has advantages for series production as a standardised heat exchanger can be used both for arrangement between two cell blocks and also for arrangement on an end cell block, for example between a housing wall and the end cell block. In order to increase the energy efficiency some of the standardised heat exchangers are adapted for use at end cell blocks in that one of the chambers of the heat exchanger in question is blocked, for example with the filler. During manufacturing this can take place in that before applying one of the two film walls of the heat exchanger to the frame, the filler, for example in the form of a sealing bead, is applied to one lateral surface of the frame. The film wall is then applied and pressed against the frame. Through this the filler disperses and flows into the flow channels which it blocks. The film wall can then be welded to the frame.

In thus far it is preferable in accordance with a secondary aspect of the invention if a method is used to manufacture the heat exchanger in which the frame and the film walls are welded together with a laser.

Welding of the edges of the film walls can take place by way of a scanner laser welding process. In connection with this it can also be envisaged that the film walls are connected by means of two welding seams which extend at a constant distance from one another. This forms additional protection against leakage. In particular, through this a redundancy is produced so that tightness of the heat exchanger is also guaranteed if one of the welding seams has holes.

As part of the present application a motor vehicle, in particular a hybrid vehicle, which comprises an above-described battery, is also disclosed and claimed. The battery comprises the heat exchanger mentioned here.

The invention will be described below in more detail with the aid of an example of embodiment with reference to the accompanying schematic drawings. In this:

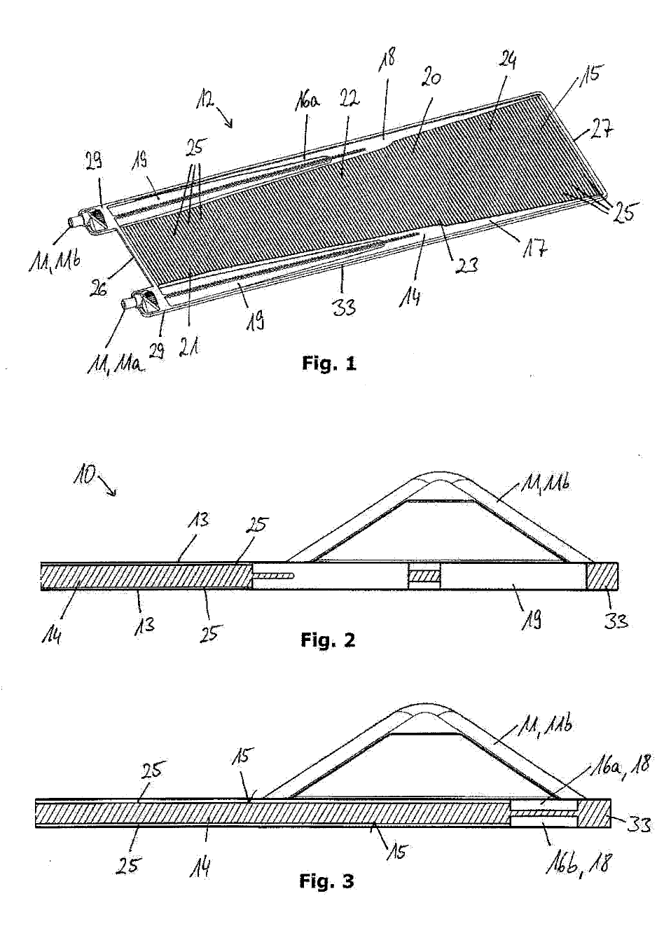

FIG. 1 shows a perspective view of a frame for a heat exchanger according to the invention;

FIG. 2 shows a partial cross-section with the frame according to FIG. 1 in a first area of the channel field which is arranged close to the connections of the heat exchanger;

FIG. 3 shows a partial cross-section through the heat exchanger according to FIG. 2 in a third area of the channel field which is arranged further away from the connections;

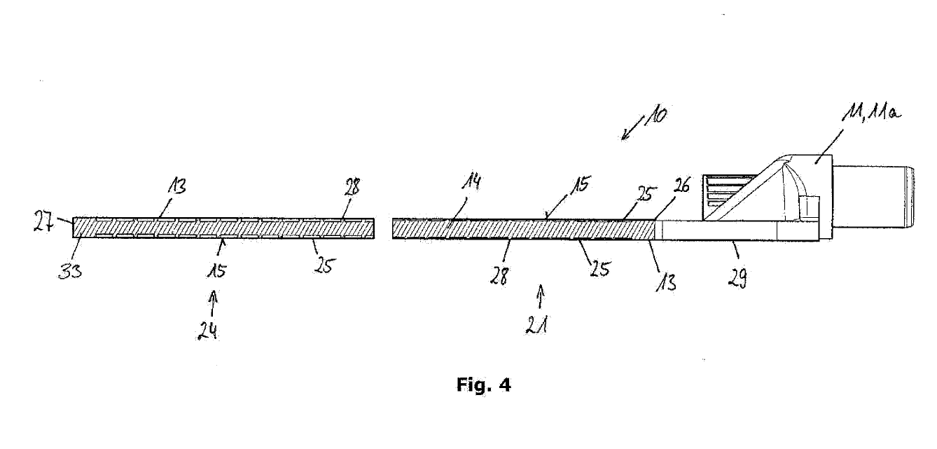

FIG. 4 shows interrupted longitudinal section through the heat exchanger according to FIG. 2 wherein the first area and the third area of the channel field are shown; and

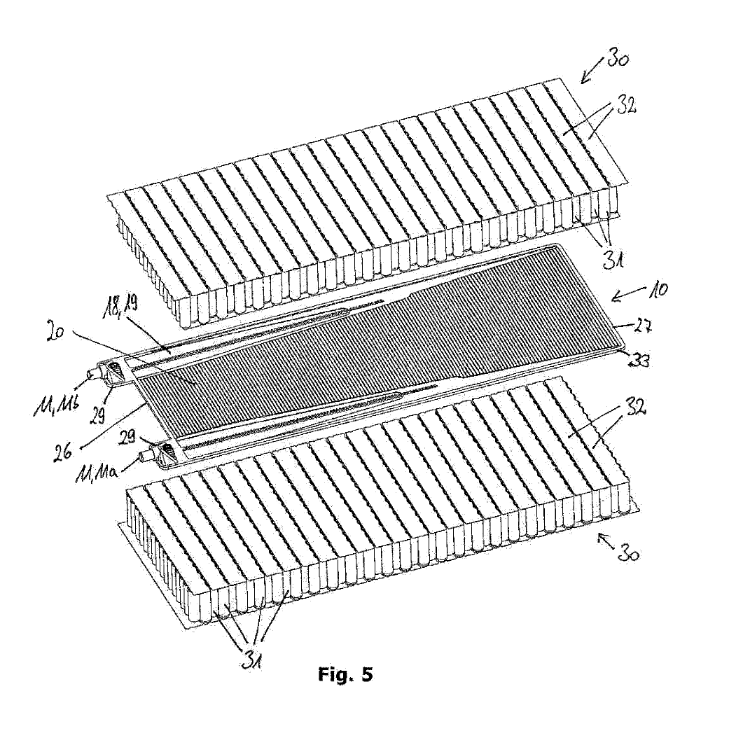

FIG. 5 shows a perspective view of cell block with the heat exchanger according to claim 2.

In FIG. 1 a frame 12 of a heat exchanger is shown, wherein the frame 12 together with flexible film walls 13 can form a pouch 10 of the heat exchanger. The design of the pouch 10 is shown in detail in FIGS. 2 to 4.

The frame 12 is preferably made of a plastic, more particularly polypropylene and comprises connections 11 formed in one piece with the frame 12. In particular a inflow connection 11a and an outflow connection 11b are provided. The connections 11 are identical so that their function is interchangeable. In other words the two connections 11, both for the inflow connection of a heat exchange medium and also for the outflow of a heat exchange medium can be used depending on how the heat exchanger is incorporated into a cooling circuit for a battery.

As can easily be seen in FIG. 1, the frame 12 has a channel field 20 which is formed of flow channels 25 which run in parallel to each other and transversely to the longitudinal axis of the pouch 10. The flow channels 25 are fluidically connected to a distribution channel 17 which is assigned to the inflow connection 11a as well as to a collecting channel 18 which is assigned to the outflow connection 11b. In an analogue manner to the connections 11 function inversion is also possible in the case of the distributor channel 17 and collecting channel 18, depending on how the heat exchanger is incorporated into a cooling circuit. The designation of the distributor channel 17 and collector channel 18 is thus dependent on the flow direction of the heat exchange medium.

The frame 12 comprises or forms a separating plate 14. On the narrow side of the frame 90 or the separating plate 14 there are two projections 29 which bear the connections 11. The frame 12 is formed in one piece of a uniform material. In particular, the frame 12 can be designed as an injection moulded component.

Openings 19 are arranged in the separating plate 14 wherein one connection 11 is assigned to one opening 19. In particular, starting from the connection 11 the opening 19 extends in parallel to the longitudinal axis of the pouch 10 or the frame 12. The opening 19 makes possible a fluidic connection between two chambers 16a, 16b of the pouch 10 which are separated from each other by the separating plate 14. The openings 19 extend in particular along the distributor channel 17 and the collecting channel 18 and keep to the dimensions, especially the width, of the distributor channel 17 and collecting channel 18.

The channel field 20, which is formed of several flow channels 25 is also produced in one piece with the frame 12 or the separating plate 14. More particularly the separating plate 14 has several webs 28 on both of its lateral surfaces 15 which separate the individual flow channels 25 from each other. The webs 28 are preferably regularly spaced so that all flow channels 25 have a uniform width. However, the length of the webs 18 or the flow channels 25 varies along the channel field 20.

Overall the channel field 20 can be divided into several areas 21, 22, 23, 24. Specifically it is envisaged that at the connection-side end 16 the channel field 20 has a first area 21. In the longitudinal direction of the frame 12 a second area 22 adjoins the first area 21. There then follows a transition area 23. At the end 27 of the pouch 10 opposite the connections 11 the channel field 20 concludes with a third area 24.

The individual areas 21, 22, 23, 24 differ in particular through the length of the flow channels 25 contained therein. In addition, the height of the flow channels 25 varies, which will be dealt with in more detail below in connection with FIG. 4.

Specifically it is envisaged that the flow channels 25 in the first area 21 essentially have a uniform length. In the second area 22 which adjoins the first area 21 the flow channels 25 have a length or channel length which continuously increases with increasing distance from the connection-side end 26. To this extent the second area 22 forms a trapezoidal shape wherein the lateral surfaces of the trapezium converging towards each other are defined by the inflows and outflows of the flow channels 25. As can be easily seen in FIG. 1 the frame 12 has an essentially rectangular basic shape. Consequently it is envisaged that the distributor channel 17 and the collecting channel 18 narrow continuously in the second area 22. The same applies in the case of the openings 19 which follow the contour of the distributor channel 17 and/or the collecting channel 18.

In the transition area 23 which is arranged between the second area 22 and the third area 24, there is a considerably greater increase in the channel lengths of the flow channels 25 than in the second area 22. This can be easily seen in FIG. 1. In other words, in the transition area 23 the channel field 20 broadens out more than in the second area 22. The increase in the channel lengths in the transition area 23 is also greater than in the third area 24. The third area 24 adjoins the transition area 23 and also exhibits a continuous increase in the channel lengths of the flow channels 25. In this way the channel length increases with increasing distance from the connection-side end 26 of the frame 12 up to a maximum. At the maximum the flow channel 25, in particular the flow channel 25 arranged furthest away from the connection-side end 26 or closest to the opposite end 27, has a channel length that almost corresponds to the width of the frame 12 or the pouch 10. At its longitudinal ends the longest flow channel 25 has lateral oblique openings which are fluidically connected to the distributor channel 17 and the collecting channel 18 respectively.

As can also be seen in FIG. 1, the different areas 21, 22, 23, 24 have different lengths seen in the longitudinal direction of the frame 12. In other words the number of flow channels 25 varies from area to area. The transition area 23 has the lowest number of flow channels 25. The greatest number of flow channels 25 is to be found in the second area 22. The third area 24 has a number of flow channels 25 which is smaller than in the second area 22 and larger than in the first area 21.

The design of the channel field 20 described here allows an essentially uniform flow speed of a heat exchange medium to be achieved over all the flow channels 25. This is particularly advantageous for efficient heat exchange. Accordingly it is also envisaged that identical channel fields 20 are arranged on both sides of the separating plate 14, i.e. on both lateral surfaces 15 of the separating plate 14.

The pouch 10 of the heat exchanger is formed in that onto both lateral surfaces 15 of the frame 12 flexible film walls 13 are applied which are firmly connected to the frame 12 in a fluid-tight manner. More particularly the film walls 13 can be welded to the frame 12. This can take place for example by means of a laser welding process. In doing so the film walls 13 are in particular firmly connected to the webs 28 as well as to an outer edge 33 of the frame. The outer edge 33 projects beyond the lateral surfaces 15 of the separating plate 14, and has a uniform thickness. The surfaces of the outer edge 33 thereby each define a common connection plane in which the surfaces of the webs 28 also lie. In this way the film walls 13 can be arranged flat on the frame 12 and be tightly applied to the outer surface of the webs 28 and the outer edge 33.

In FIG. 2 the cross-sectional structure of the pouch 10 of the heat exchanger is shown, wherein the cross-section is shown at the connection-side end 26 of the pouch 10. FIG. 2 show the separating plate 14, the core area of which at the connection-side end 26 of the frame 12 has a relatively large wall thickness. Consequently the flow channel 25 shown in cross-section here has a relatively low height. Through adjusting the height of the flow channel 25 the flow speed in the flow channel 25 can be set. As with increasing distance to the connection-side end 26 of the pouch 10 the volume fluid available for supplying to the individual flow channels 25 decreases, it is envisaged that with increasing distance from the connection-side end 26 the height of the flow channels 25 increases. In this way the flow cross-section in the flow channels 25 is successively, in particularly not necessarily linearly, increased from the connection-side end 26 to the opposite end 27 so that when fluid flows through this results in a uniform flow speed in the channel field 20.

In the cross-sectional view according to FIG. 2 the opening 19 which connects a first chamber 16a and a second chamber 16b of the pouch 10 can also be seen. The first chamber 16a and the second chamber 16b are separated from each other by the separating plate 14. On an outer side of the pouch 10 the opening 19 is defined by the outer edge 33 of the frame 12. In addition, in FIG. 2 a rear view of the fluid connection 11 is shown. It can be easily seen that the fluid connection 11 essentially has a roof-shaped cross-sectional contour. This shape is advantageous in order to transfer the fluid flow of the heat exchange medium with the smallest possible decrease in pressure from a round cross-section at the connection 11 into the flat distributor channel 17 and/or collecting channel 18.

Via the round inflow connection 11a the heat exchange medium enters the flat distributor channel 17, wherein through the opening 19 an even distribution of the fluid flow to the first chamber 16a and the second chamber 16b is achieved. The distributor channel 17 distributes the fluid flow to all flow channels 25 of the channel field 20. Accordingly the distributor channel 17 extends over the entire length of the pouch 10 or the channel field 20. After flowing through the individual flow channels 25 the heat exchange medium reaches the collecting channel 18 wherein the fluid flows from the collecting channels 18 on both sides of the separating plate 14 are combined through the opening 19. It is envisaged that both openings 19 only extend over part of the length of the pouch 10, for example over around half the length of the pouch 10. In all cases the openings 10 end before the transition area 23 of the channel field 20. The heat exchange medium flowing in the collecting channel 18 then leaves the pouch 10 via the drainage connection 11b.

FIG. 3 shows a partial cross-sectional view through the pouch 10 at the end 27 of the pouch 24 opposite the connections 11, i.e. at the third area 24 of the channel field 20. It can easily be seen that the flow channel 25 has a greater length than the flow channel 25 at the connection-side end 26 which is shown in FIG. 2. It can also be seen that the separating plate 14 extends over the entire width of the pouch 10. In the third area 24 of the channel field 20 shown here no opening 19 is arranged. Instead, the chambers 16a, 16b are clearly separated from each other wherein each of the chambers 16a, 16b has a collecting channel 18. It can also be seen that the height of the flow channel 25 at the opposite end 27 is greater than at the connection-side end 26 (FIG. 2).

The different height of the flow channels 25 is also shown in FIG. 4 which shows a cross-sectional view through the pouch 10. For reasons of clarity the cross-sectional view is interrupted in the middle so that shown in the left half of the drawing is an end 27 of the pouch 10 located opposite the connections 11, in particular the third area 24 of the channel field 20. Shown in the right half of the drawing is the connection-side end 26 of the bag 10, in particular the first area 21 of the channel field 20. It can be seen that the flow channels 25 in the first area 21 have a considerably smaller height than the flow channels 25 in the third area 24. The variation in height takes place through reduction in the wall thickness of the core area of the separating plate 14 so that the surfaces of the webs 28 are arranged in a common plane or are in alignment with each other. In connection with this it is pointed out that the height of the flow channels 25 from the connection-side end 26 to the opposite end 27 of the pouch 10 can increase continuously. However, it is preferable if the height of the flow channels 25 changes in sections from the connection-side end 26 to the opposite end 27 of the pouch 10 or the frame 12. More particularly, within the first area 21, the second area 22, the transition area 23 and the third area 24 the flow channels 25 can each have a uniform height.

The heat exchanger described here is preferably used for cooling a battery. The internal structure of such a battery is shown as an example by way of the exploded diagram according to FIG. 5. A battery, which is preferably used for a hybrid drive or as an energy store for a hybrid vehicle, comprises at least two cell blocks 30 which are each built up of individually electrically and mechanically interconnected battery cells 31. The battery cells 31 are preferably designed as round cells which are arranged standing in series. The battery cells 31 are electrically and mechanically connected through contact plates 32, wherein the contact plates 32 each connect the end side poles of adjacent battery cells 31 to one another. The pouch 10 is arranged between the cell blocks so that via the contact plates 32 heat exchange from the cell blocks 30 to the pocket 10 is made possible. The inner structure of the battery in FIG. 5 is preferably integrated into a housing, wherein the housing has means which clamp the cell blocks 30 and the pouch 10 to each other in order to maintain a continuous and good thermally conductive contact.

For such a battery it is also preferably envisaged that each cell block 30 is arranged between two heat exchangers or pouches 10. The pouch 10 can thus not only extend between two cell blocks 30 but also cover an end-side cell block 30. In this case only one of the two chambers 16a, 16b removes heat from the call block 30. The second chamber of the pouch 10, which faces away from the cell block does not contribute to the cooling of the cell block 30. In thus far it is preferable if the chamber 16a, 16b facing away from the cell block 30 is filled with a filler that prevents fluid flowing in the chamber 16a, 16b facing away from the end-side cell block 30. In other words one of the two chambers 16a, 16b can be deactivated. This increases the efficiency of the heat exchanger system.

### LIST OF REFERENCE NUMBERS

10 Pouch
11 Connection
11a Inflow connection
11b Outflow connection
12 Frame
13 Film wall
14 Separating plate
15 Lateral surface
16a First chamber
16b Second chamber
17 Distributor channel
18 Collecting channel
19 Opening
20 Channel field
21 First area
22 Second area
23 Transition area
24 Third area
25 Flow channel
26 Connection-side end
27 Opposite end
28 Web
29 Projection
30 Cell block
31 Battery cell
32 Contact plate
33 Outer edge

1. Heat exchanger for a battery, in particular for a hybrid drive, with connections for the inflow and outflow of a heat exchange medium and with a frame which is connected on both sides with film walls to form a pouch through which a flow can pass, wherein the frame comprises flow guiding elements,
characterized in that
the frame comprises a separating plate with two parallel lateral surfaces, wherein the separating plate divides the pouch into a first chamber and a second chamber which are delimited in a fluid-tight manner by the lateral surfaces and the respective film walls, wherein in each of the lateral surfaces a channel field of parallel flow channels is formed, the inflow side of which is fluidically connected via a distributor channel and the outflow side of which is fluidically connected via a collecting channel to the respective connections.

2. Heat exchanger according to claim 1,
characterized in that
the flow channels are arranged transversely to the longitudinal axis of the pouch.

3. Heat exchanger according to claim 1,
characterized in that
the maximum length of the flow channels is equivalent to the width of the pouch.

4. (canceled)

5. Heat exchanger according to claim 1,
characterized in that
the channel field comprises a first area with the same channel length, a second area with a constantly increasing channel length, a transition area with a greater increase in the channel length than in the second area and a third area with a constantly increasing channel length.

6. Heat exchanger according to claim 1,
characterized in that
the flow channels have a uniform width, wherein a height of the flow channels increases from a connection-side end to an end of the heat exchanger opposite the connections.

7. Heat exchanger according to claim 1,
characterized in that
the separating plate has two openings which each emanate from the connections and each extend in parallel to the longitudinal axis of the pouch along the channel field, more particularly along the first area and, at least in sections, along the second area.

8. Heat exchanger according to claim 1,
characterized in that
a cross-sectional area of the distributor channel decreases from a connection-side end to an end of the heat exchanger opposite the connections.

9. Battery with at least one heat exchanger according to claim 1 with at least two cell blocks of round cells to be tempered, wherein the heat exchanger is arranged between the cell blocks and during operation of the first chamber tempers one of the two cell blocks and the second chamber of the heat exchanger tempers the other one of the two cell blocks.

10. Battery according claim 9,
characterized in that
for tempering an end-side cell block the chamber of the heat exchanger facing away from the cell block is filled with a filler which blocks the flow channels.

11. Vehicle, in particular a hybrid vehicle with a battery according to claim 9.

12. Method of manufacturing the heat exchanger according claim 1 in which the frame and the film walls are welded together with a laser.

13. Method according to claim 12,
characterized in that
the film walls are connected by means of two welding seams which extend at a constant distance from one another.
